(19) United States
(12) Patent Application Publication
(10) Pub. No.: US 2015/0339726 A1
(43) Pub. Date: Nov. 26, 2015

(54) ADVERTISING FOR SENSOR-ENABLED CLOTHING

(71) Applicant: TOSHIBA GLOBAL COMMERCE SOLUTIONS HOLDINGS CORPORATION, Tokyo (JP)

(72) Inventors: Dean Frederick Herring, Youngsville, NC (US); Brad Matthew Johnson, Raleigh, NC (US); Jason Monsak Chirakansakcharoen, Raleigh, NC (US); Jeffrey John Smith, Raleigh, NC (US)

(73) Assignee: TOSHIBA GLOBAL COMMERCE SOLUTIONS HOLDINGS CORPORATION, Tokyo (JP)

(21) Appl. No.: 14/286,093

(22) Filed: May 23, 2014

(51) Int. Cl. G06Q 30/02; H04L 29/08

(52) U.S. Cl. CPC G06Q 30/0269; G06Q 30/0261; H04L 67/12

(57) ABSTRACT

A system, computer program product, and method for advertising that include coupling a body-worn sensor device associated with an article of clothing to a receiver, and retrieving data from the sensor device. The retrieved data includes one or more measures indicating a state of wear of the article of clothing. The method further includes generating an advertisement based on the retrieved data.

### BACKGROUND

The present invention relates to generating real-time advertising, and more specifically, to generating advertising based on sensor data.

Wearable sensor technology is increasing in popularity, especially as individuals seek to collect and analyze data of the events of daily life in order to understand and thereby improve personal health and wellness. Activity trackers are one example of wearable sensors and may interface with an application to monitor and track fitness-related metrics such as walking distance, calorie consumption, heartbeat, quality of sleep, and so forth.

### SUMMARY

According to one embodiment, a system includes a receiver configured to receive data wirelessly from a body-worn sensor device. The received data includes one or more measures indicating a state of wear of an article of clothing associated with the sensor device. The system also includes a computing device coupled to the receiver and including an advertising module configured to generate an advertisement based on data received from the sensor device, and a display module configured to present the advertisement.

According to one embodiment, a non-transitory computer-readable medium includes computer-readable code, which when executed on a processor, performs an operation that includes retrieving data from a body-worn sensor device associated with a first article of clothing. The data includes one or more measures indicating a state of wear of the first article of clothing. The operation further includes generating an advertisement based on the retrieved data.

According to one embodiment, a method for advertising includes coupling a body-worn sensor device associated with a first article of clothing to a receiver, and retrieving data from the sensor device. The retrieved data includes one or more measures indicating a state of wear of the first article of clothing. The method also includes generating an advertisement based on the retrieved data.

### BRIEF DESCRIPTION OF THE SEVERAL VIEWS OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an advertising system, according to one embodiment described herein.

FIG. 2 illustrates an advertising system, according to one embodiment described herein.

FIG. 3 illustrates a deployment of an advertising system in a retail environment, according to one embodiment described herein.

FIG. 4 illustrates operation of a fashion module for an advertising system, according to one embodiment described herein.

FIG. 5 illustrates a method for advertising, according to one embodiment described herein.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

To provide real-time, relevant advertising to consumers, an advertising system is disclosed that includes various articles of clothing, each of which includes sensor devices. A receiver may wirelessly couple with the sensor devices and retrieve data from the sensor devices; the data includes one or more measures of the state of wear of the clothing. A computing device coupled to the receiver may include an advertising module that generates an advertisement based on the retrieved data, and a display module that is configured to present the advertisement to a wearer of the clothing corresponding to the sensor devices.

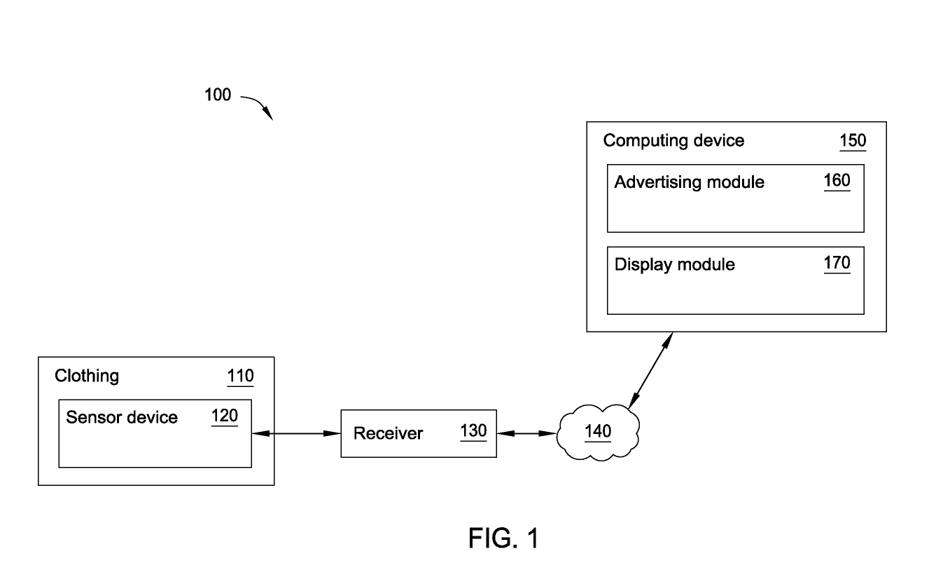

FIG. 1 illustrates an advertising system, according to one embodiment described herein. The advertising system 100 includes one or more articles of clothing 110 that include at least one respective sensor device 120. Clothing 110 generally includes materials of any type that may be worn on the body, whether natural or synthetic in origin. For example, clothing 110 may include fiber or textile materials, or garments including animal skin, hair, or fur. The clothing 110 may include garments or wear intended for any suitable purpose, such as formal wear, casual wear, athletic wear, and so forth. Additionally, clothing 110 may include wearable devices, whether worn externally on the body or implanted within the body. Some examples of wearable devices include active medical devices such as pacemakers, cochlear implants, drug-eluting stents, and so forth.

The sensor device 120 may include one or more different types of sensors or devices capable of measurement. For example, sensor device 120 may include pressure sensors, temperature sensors, humidity sensors, strain gages, as well as any other devices that are capable of measuring different indicators of clothing wear. For example, a sensor device 120 could measure the color of clothing 110 to determine how much the clothing has faded from an original color. As will be discussed more fully below, a sensor device 120 may include additional circuitry, including a memory for storing the sensed or measured data and any additional information about the clothing or its history or state of wear. The memory of the sensor device 120 may be accessed by a receiver 130, and the data may ultimately be used to generate advertising targeted to a wearer of the clothing 110. As defined herein, advertising may include promotions, coupons, product advertisements, event notifications, sponsored charities, etc. The advertising may promote sales of new or used items to consumers or may promote the purchase of consumers' items (e.g., “gently worn” clothing).

The sensor device 120 may be included as a discrete device or assembly within clothing 110 (e.g., embedded or attached) and/or may be integrally formed into the clothing 110. For example, sensor device 120 may include a strain gage on a thread woven into the fabric of a garment, which may be coupled to other circuitry of sensor device 120 that is included as a discrete unit in the garment (e.g., disposed between two layers of fabric). In some embodiments, the sensor device 120 may be included with clothing 110 at the time of manufacture. In other embodiments, the sensor device 120 may be retrofitted to existing items of clothing. The sensor device 120 may be water-resistant or water-proof, and may be suitable for use in wet or humid environments (e.g., rain, sweat), and may withstand other uses of the clothing (e.g., machine washing).

The sensor device 120 and its components may be passive, active, or self-powered. In one embodiment, sensor device 120 may be passive and may receive electrical energy needed to operate from its corresponding receiver. For example, sensor device 120 may include a radio frequency identification (RFID) tag that is enabled by a powered RFID reader. In another embodiment, the sensor device 120 may receive electrical energy from the wearing of the clothing 110; for example, piezoelectric materials (such as fibers or discrete sensors) may be included in clothing 110 and generate charge as the materials are subject to varying pressure. In another example, the clothing 110 may include photovoltaic elements that may convert ambient light into usable energy that powers sensor device 120.

The sensor device 120 may be a multicomponent device, in which a portion of the sensor device is permanently embedded in the clothing, and a portion is removable. In one embodiment, a storage element and sensor are embedded while a wireless transmitter component is removable. In this way, the wireless transmitter may be selectively coupled and decoupled from the embedded elements, and may thus be used to couple with more than one article of clothing. Using a common wireless transmitter, or any removable component, across different sensor devices may provide a lower cost for implementation.

Receiver 130 is generally configured to communicatively couple to sensor device 120 and to one or more computing devices 150, in order to transmit data retrieved from sensor device 120. Receiver 130 may be configured to couple wirelessly with sensor device 120. In one embodiment, receiver 130 may be an RFID reader. In other embodiments, the receiver 130 may communicate using other wireless connections, such as Wi-Fi, Bluetooth, Near Field Communication, or infrared. In some embodiments, receiver 130 may include point receivers, which may be disposed at discrete locations. Other embodiments may include area receivers, in which the receiver is more or less continuous over a significant area; an example of this might be a sensor array or mesh embedded in the floor, wall, or ceiling of a store.

In one embodiment, receiver 130 may be included as a module, peripheral, or component of the computing device 150, either through a direct coupling or a wireless coupling. For example, receiver 130 may be an external peripheral device connected to computing device 150 using a wired connection and communication using Universal Serial Bus (USB) protocols. Of course, other configurations and communications protocols may be used.

In another embodiment, receiver 130 may be a separate computing device or system that includes independent processing, memory, and communications capabilities. For example, receiver 130 may be included in a standalone terminal or kiosk in a retail store that communicates with other terminals and with a central server. In this embodiment, the computing system including receiver 130 may be networked to computing device 150 through network 140 and using suitable communications protocols, such as Transmission Control Protocol/Internet Protocol (TCP/IP). Network 140 may generally be a local area network (LAN) or wide area network (WAN), and may connect one or more receivers 130 to one or more computing devices (such as computing device 150) as well as other networked devices (such as servers and storage). Network 140 may also be deployed as part of a cloud computing environment.

Computing device 150 may generally be any device that includes processing, memory, and communications capabilities (these functions will be discussed further below). Computing device 150 may include computers of all sizes and shapes, such as desktop computers, laptop computers, netbook computers, tablets, web browsers, e-book readers, and personal digital assistants (PDAs). Computing device 150 may also include remote terminals or kiosks generally distributed through a retail store. Other examples of computing device 150 include communication devices (including cellular phones, such as smart phones) and point-of-sale devices (including cash registers or terminals).

Computing device 150 includes an advertising module 160 that is generally configured to generate advertising based on data received from sensor devices 120. Computing device 150 also includes a display module 170 that is configured to present the generated advertisements to a wearer of clothing 110. Each of these modules will be explained in greater detail below.

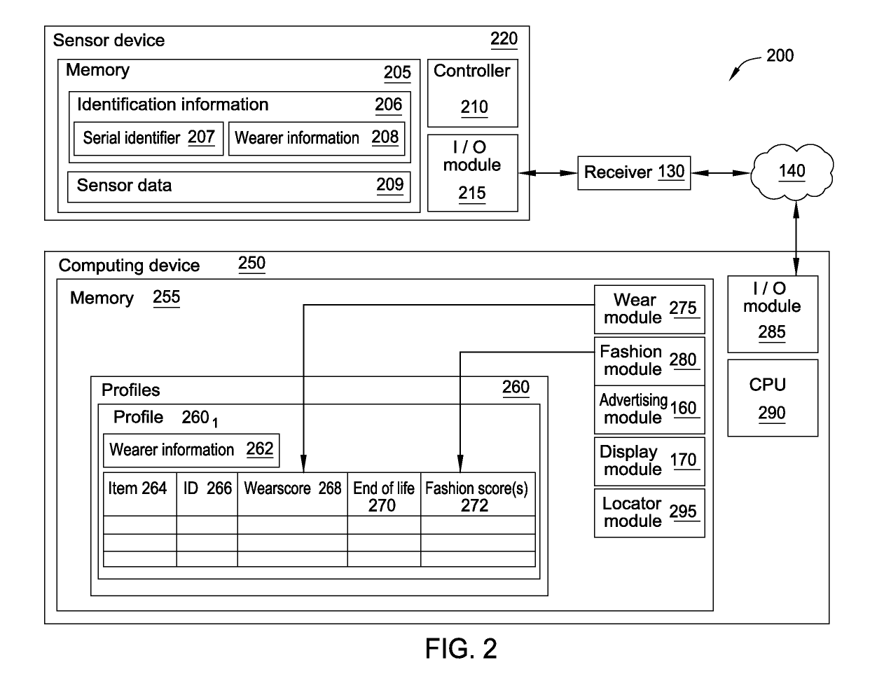

FIG. 2 illustrates an advertising system, according to one embodiment described herein. As shown, advertising system 200 is one possible configuration of the advertising system 100 described above. Advertising system 200 includes a sensor device 220, which may be included in an article of clothing (such as clothing 110) and may be coupled to receiver 130. In turn, the receiver 130 may be coupled to a computing device 250 through a network 140.

As shown, sensor device 220 is one possible configuration of the sensor device 120 described above, and may operate similarly to sensor device 120. Sensor device 220 includes a memory 205, a controller 210, and an input/output (I/O) module 215.

Controller 210 is generally configured to read and execute code stored in memory 205, and to communicate with various peripheral devices and/or other computing systems through I/O module 215. Controller 210 may be a microcontroller or another integrated circuit that includes processing capabilities. While controller 210 may include general-purpose microprocessors, many configurations of sensor device 220 may require low power consumption and small component size, which may generally be better suited to the use of microcontrollers. Though shown as separate elements of sensor device 220, controller 210 may include some or all of memory 205 and I/O module 215 natively.

Memory 205 may include both volatile memory, such as various types of random access memory (RAM), as well as one or more forms of non-volatile memory (e.g., hard drives, solid state drives, Flash memory, etc.). Memory 205 may include identification (ID) information 206, as well as sensor data 209. ID information 206 may include identifiers for the sensor device 220 and for the clothing in which it is included. For example, ID information 206 may include a serial identifier 207 that uniquely identifies the sensor device 220 and/or the clothing, and may include additional wearer information 208. For example, the wearer's identity (whether the person's name or some other value identifying the wearer) may be stored in wearer information 208, which may be used to access a profile containing information about the wearer. Sensor data 209 may include various sensor readings or measurements from the sensor devices described above.

Sensor data 209 may include one or more measures of wear of the clothing corresponding to the sensor device 220. For example, the measures of wear may include historical and/or current data related to the environment (e.g., temperature, humidity, light intensity) that may affect the longevity of the clothing. The measures of wear may also include historical and/or current data that indicates the manner in which the clothing is or was worn (e.g., pressure or strain measurements), and may also include measurements of the properties of the clothing (e.g., color fade). For the example of wearable devices, measures of wear may relate to the state of the device, such as a battery charge or remaining lifetime, an amount of drug remaining, etc. The sensor data 209 may also reflect interactions with other appropriately enabled devices; for example, the sensor data may include a counter that is incremented every time the sensor device 220 communicatively couples to a receiver included on a washing machine. Coupling the sensor device 220 in this manner may indicate that the item of clothing was washed, which generally serves as a measure of wear of the clothing (i.e., the more times clothing is washed, the more likely it is to deteriorate).

The I/O module 215 is generally configured to communicate with receiver 130 and may be included as part of controller 210 or separately. Through receiver 130, the sensor device 220 may be coupled to computing device 250, which is generally able to retrieve and process data from memory 205.

Computing device 250 may generally be any device that includes processing, memory, and communications capabilities. Computing device includes a central processing unit (CPU) 290, memory 255, and I/O module 285. CPU 290 may represent a single processor, multiple processors, a processor or processors having multiple cores, as well as combinations thereof.

I/O module 285 may include one or more paths for communication with various devices or components of the computing device 250 as well as other external networked devices. The I/O module 285 may include buses, networks, and other wired or wireless interconnections, some examples of which include I²C, SPI, PS/2, USB, Bluetooth, RF, and IRDA. Communications between devices may use any feasible protocol or combination of protocols; for example, computing device 250 may communicate with external devices (e.g., other networked computing systems, servers, storage, etc.) using TCP/IP protocols, while communicating with local devices using USB protocols. In some embodiments, receiver 130 may be a local device to computing device 250, while in other embodiments, receiver 130 may be externally networked to computing device 250.

The memory 255 may include volatile and/or non-volatile memory, and may include RAM, Flash memory, cache, disk drives, solid state drives, and the like. Although shown as a single entity, the memory 255 may be divided into different memory elements, such as RAM and one or more hard disk drives. Memory 255 may contain several functional modules for the advertising system 200 including a wear module 275, a fashion module 280, an advertising module 160, a display module 170, and a locator module 295. Of course, any of these modules could alternatively be implemented in computing device 250 but outside of memory 255 (for example, as a separate controller circuit).

Wear module 275 is generally configured to receive data from sensor device 220, and to calculate a wear score based on that data. The wear score generally represents an estimated level of wear of the clothing that corresponds to sensor device 220. The wear module 275 may also be configured to calculate an estimated end-of-life for the clothing, based on the data and/or the wear score. These estimates may be stored (e.g., in profile 260 discussed below), and may be used by the advertising module 160 to generate relevant advertising for a wearer of the clothing.

Fashion module 280 is generally configured to receive data from sensor device 220, and to calculate a fashion score based on that data. The fashion score may represent a number of factors, such as compatibility of the particular clothing with other sensor-enabled clothing linked to the wearer, as well as style values that may be provided and modified by clothing manufacturers or resellers. Based on the various factors, a fashion score may be calculated using fashion module 280, and then used by the advertising module 160 to generate relevant advertising for a wearer of the clothing. For example, advertising module 160 may generate advertising in an attempt to increase the wearer's fashion score, by suggesting different clothing or accessories that may be considered more stylish, or that offer increased compatibility with the wearer's clothing items.

Advertising module 160 is generally configured to generate advertising based on data received from sensor devices 220. Advertising may be in any form, from simply portraying or describing a product, provider, or service, to offering personalized sales promotions to a potential consumer. Additionally, advertising module 160 may determine the medium or media for the generated advertising, which may be a visual display, audio, a printed coupon or flyer, an email or text message alert to the wearer, and so forth. No matter which media are selected, the advertising content may include images, textual descriptions, uniform resource locators (URLs), bar codes (including Quick Response Codes), video, audio, etc.

The data retrieved from the sensor devices 220 may relate to identification and/or the wear of certain clothing corresponding to the sensor devices, but may also include additional information, such as location(s) of those sensor devices 220 (e.g., a position within a retail store). Further, the advertising may also be based on other identification or historical information about the wearer (e.g., purchasing history, activity, preferences, etc., which may be stored in profile 260). Of course, the advertising need not be limited to replacement or additional clothing items, but may be for any types of products and/or services that may be relevant or of interest to the wearer. For example, a sensor device 220 located in running shoes may couple to a receiver 130 in a shopping mall. Based on information identifying the shoes, a wear level of the shoes, and other information about the wearer and his/her activity history, advertising module 160 may generate relevant advertising, such as promotions for replacement shoes (e.g., promoting new models), for athletic apparel, for other specific sports, fitness, or health products, for sporting goods stores in the mall, and so forth.

Locator module 295 is generally configured to determine a location of a sensor device 220 based on the data received from the sensor device. For example, a wearer of sensor-enabled clothing may be located in a retail store; based on one or more receivers 130 coupling to the sensor device 220, a position of the sensor device (and thus, the wearer) may be determined or estimated. And based on this position information, advertising module 160 may produce relevant advertising for the wearer. For example, the advertising module 160 may produce advertising related to a particular store, department or area within a store, or products that are proximate to the wearer's position (or to his/her direction of movement, etc.). In this way, the wearer's attention may be timely captured by the advertising, which may produce more effective results (i.e., greater sales generated as a result of the advertising).

Display module 170 is configured to receive the generated advertisement from advertising module 160, and to present the advertisement to the wearer. Advertising module 160 may generally select the content and formatting of the advertisement, which may include images, text, video, audio, and so forth. Display module 170, in turn, may select an appropriate location and/or presentation device used for the presentation of the advertisement. For example, and as will be discussed further below, display module 170 may use position information of sensor devices 220 to determine where in a store (or other area) to present the generated advertisement. Display module 170 may select from available presentation assets (e.g., kiosks, display screens, computers at cash registers within the store, employee hand-held devices, wearer hand-held devices, etc.) and may select to present using assets nearest to a wearer's position or projected path, or which are otherwise calculated to have greatest effect on a wearer. In some embodiments, the display module 170 (and computing device 250) may be collocated with a display device, such as a liquid crystal display (LCD) screen or any other type of display. In some embodiments, the display device may be an integrated device that includes input capabilities and display capabilities (e.g., a touch-screen LCD).

Memory 255 may also include one or more profiles 260 each corresponding to different wearers, and that may store information about the wearer, his/her sensor-enabled clothing, activity, history, preferences, and so forth. By accessing information in a wearer's profile, the advertising module 160 may be able to produce more relevant advertising to display to the wearer.

One example profile 260₁ generally corresponds to a particular wearer. The profile 260₁ may contain wearer information 262, such as his/her name, address, email address, phone number, etc. The wearer information 262 may include a unique coded identifier that may be shared by wearer information 208 in the sensor device 220, so that the sensor device 220 may be linked to the wearer's profile 260 while maintaining the wearer's privacy (i.e., the wearer's name or other personal information will not be stored unsecured in the sensor device 220). Of course, other information about the wearer may be stored in wearer information 262, such as account information and preferences, activity history, purchasing history, etc. that may be used to present advertising to the wearer. A wearer may generally register using an application or web interface to setup a profile.

The profile 260₁ may also include information about the various sensor-enabled clothing linked to the wearer. For example, a profile may include a description of the clothing items 264 linked to the profile, unique identifiers (IDs) 266 for the items or for the corresponding sensor devices 220, wear scores 268 for the clothing items, an estimated end-of-life 270 for each of the items, and one or more fashion score(s) 272. The wear module 275 may generally calculate the wear scores 268 based on data received from sensor devices 220, and the fashion module 280 may generally calculate the fashion score(s) 272.

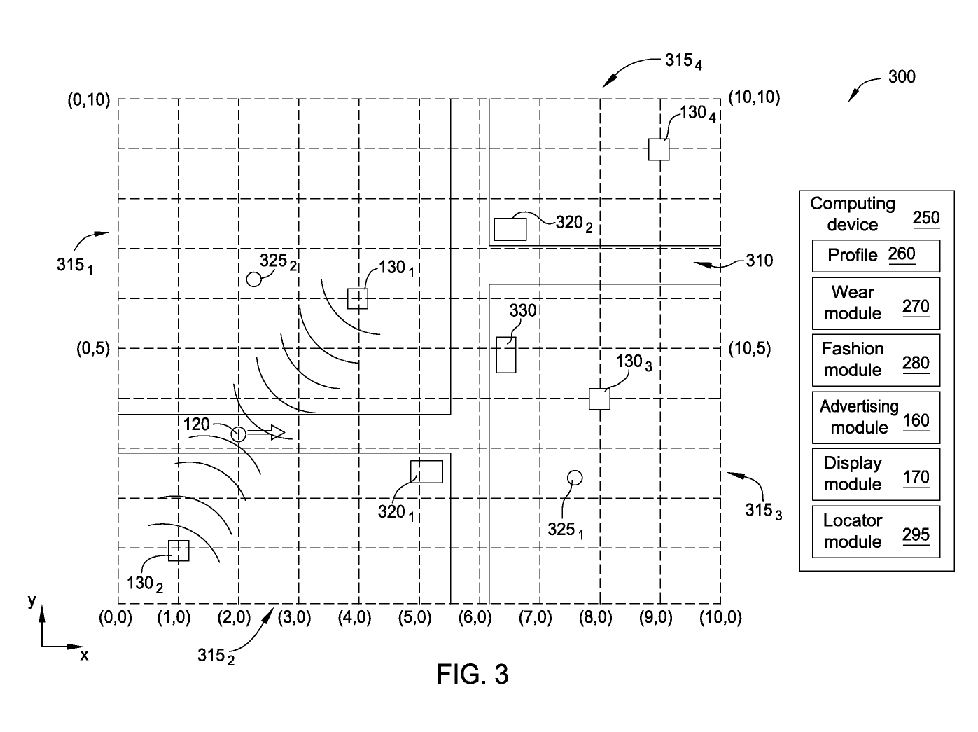

FIG. 3 illustrates a deployment of an advertising system in a retail environment, according to one embodiment described herein. Generally, advertising system 300 may operate similarly to the advertising systems 100, 200 described above. The advertising system 300 is depicted as a top-down view of a floor plan for a retail store (e.g., a department store). The floor plan includes spatial coordinates X, Y for easy reference. A walkway 310 crosses the floor, dividing the store into various areas or departments 315₁-315₄. The advertising system 300 includes a plurality of receivers 130 disposed throughout the store, which are configured to couple with various sensor devices 120 and with computing device 250. The advertising system 300 also includes multiple kiosks 320₁, 320₂ that include display screens, a cash register counter 330, and hand-held devices 325 carried by employees working out on the floor; all of these may be coupled with the display module of computing device 250. Although not shown, advertising system 300 may further be linked to a hand-held device carried by a wearer.

A sensor device 120 included in an article of clothing is located near coordinate (2,3); the wearer is moving to the right on the walkway 310 (i.e., increasing values of X). As the wearer approaches receivers 130₁, 130₂, the sensor device 120 couples with one or both of the receivers. Computing device 250 may retrieve data from the sensor device 120, including one or more measures of wear of the clothing, using the receivers 130₁, 130₂.

For example, say sensor device 120 is included in a pair of shoes, and the data provided by various sensors included in sensor device 120 indicate that the shoes have taken about 800,000 steps, the areas of greatest wear on the sole have worn down to about 30% of the original tread height, and the fabric upper has stretched by about 20%. Additionally, the sensor device 120 includes a number of times the shoes have been washed. After coupling to the sensor device 120 through receiver 130, the computing device 250 may retrieve data from the sensor device 120. The computing device 250 may retrieve wearer information first to link the sensor device to a profile 260 stored with the computing device 250 (or another networked system), and may update calculations for the sensor device 120. For example, the wear module 275 of computing device 250 may calculate or update a composite wear score considering some or all of the sensor data (such as that described above), which may also consider information stored in the wearer's profile 260, such as a purchase date or age of the shoes. Optionally, the wear module of computing device 250 may further calculate an estimated end-of-life value for the clothing based on the sensor data and/or the wear score. For example, the wear module 275 may estimate that the clothing will reach an end-of-life in a number of weeks or months, or perhaps by a certain date.

The calculated wear score or the end-of-life value may be used by an advertising module 160 of computing device 250 to generate advertising for the wearer. For example, the advertising module 160 may offer a discount on a replacement for the clothing when the wear score or end-of-life exceeds a threshold value. Alternatively, the advertising module 160 may vary the discount amount based on the wear score or end-of-life value (e.g., increasing an offered discount for a replacement when the clothing nears its estimated end-of-life, which reflects that a wearer may be more likely to replace the clothing with a replacement). Of course, optimal discount amounts (and the relation to wear score or end-of-life) could be calculated by the advertising module 160 based on historical data and/or purchasing data of the particular wearer, or compiled across multiple wearers.

The advertising module 160, based on the various factors described above, may generate an advertisement and transmit it to the display module 170 of computing device 250 in order to present the generated advertisement to the wearer. The display module 170 may generally display advertisements using any of the assets located throughout the store, such as the kiosks 320₁, 320₂, cash register counter 330, and employee hand-held devices 325 depicted. The display module 170 may alternately transmit the advertisement to the wearer using information stored in the wearer's profile 160. For example, the wearer's cellular phone number or email address may be stored in his/her profile, and the display module may transmit the advertisement in a suitable format to the wearer.

The display module 170 may use location data provided by locator module 295 in order to determine how to present the generated advertisement to the wearer. For example, locator module 295 may use a distance and/or direction of the sensor device 120 from one or more receivers 130 to determine a location of the wearer. As shown, two receivers 130₁, 130₂ are sufficiently close to couple to sensor device 120. By determining a distance and/or direction of the sensor device to each of the receivers, the locator module 295 may determine the position of the wearer with reasonable accuracy. Display module 170 may use this location data (which may also include data indicating a direction of movement of the wearer) to select where to present the generated advertisement. For example, employee hand-held device 325₂ and kiosk 320₁ are each about the same distance from the sensor device 120. Based on the position and direction of movement information, the display module may select the nearest display device in the direction that the wearer is moving (i.e., kiosk 320₁). Of course, the display device may be selected based on any number of additional or alternate factors.

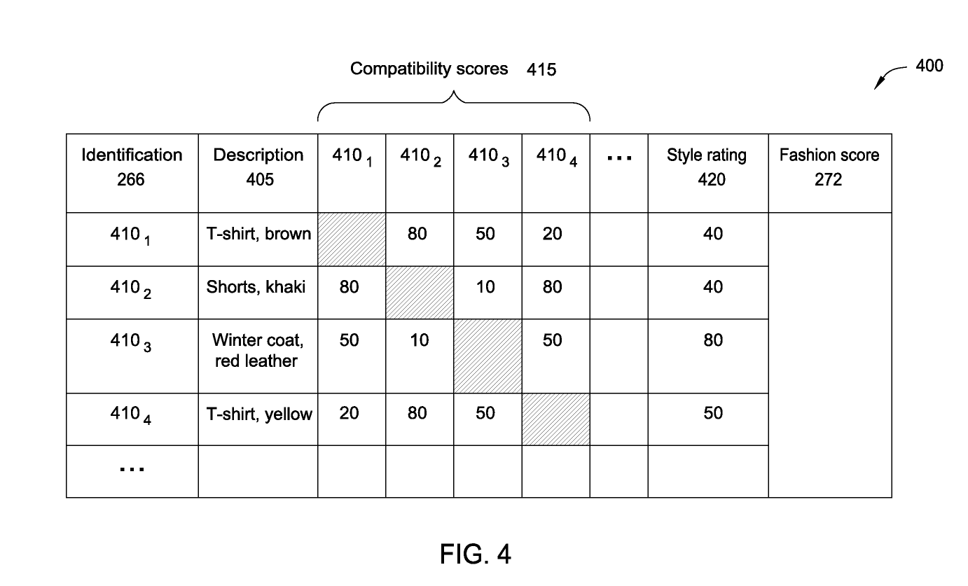

FIG. 4 illustrates operation of a fashion module for an advertising system, according to one embodiment described herein. Chart 400 represents values that may be used for calculations by a fashion module 280 to evaluate different sensor-enabled clothing to generate fashion scores 272, which may then be used by an advertising module to generate appropriate advertising for a wearer. Columns in chart 400 include clothing identification 266, description 405, compatibility 415, style rating 420, and fashion score 272.

The clothing items 410₁-410₄ each include a respective sensor device 220. As described above, certain embodiments may include multicomponent devices, in which at least one component may be shared between different sensor devices 220. To complete the chart, data may be generally retrieved from these sensor devices 220, from a profile of the wearer, or from other modules or computing systems. For example, identification field 266 may retrieve a serial identifier from the sensor device 220. Clothing items 410 that have already been linked to a wearer's profile may also be retrieved from the profile and included in chart 400. In some embodiments, the description 405 of the clothing 410 may be stored on (and retrieved from) the sensor devices 220. In other embodiments, description 405 may be downloaded or otherwise obtained using the identification 266 (e.g., from a centralized server or other computing system).

Compatibility scores 415 represent a rating of compatibility between two different clothing articles, which could be any type of numerical or logical rating. In this example, a 0 to 100 score is assigned for each combination, with 0 meaning entirely incompatible and 100 meaning entirely compatible. Compatibility scores may be based on subjective ratings of color combinations, patterns, styles, and so forth. For example, brown t-shirt 410₁ receives a score of 80 with khaki shorts 410₂, but may receive a lesser score (50) with a red coat 410₃ due to a less compatible color combination. Similarly, brown t-shirt 410₁ may receive a low score with yellow t-shirt 410₄ due to redundancy (two t-shirts are not typically needed) and color compatibility. Khaki shorts 410₂ may receive a relatively low score with red coat 410₃ due to seasonal incompatibility (i.e., a heavy winter coat would typically not be worn with summer clothes). Of course, measures of compatibility are relatively subjective. The compatibility scores 415 may be provided to the fashion module 280, and may be updated, by another module or computing device (e.g., a centralized server).

A style rating 420 may also be provided for the different clothing items 410, which may represent a measure of trendiness or fashion acceptance for the clothing. Of course, the style ratings 420 are also subjective; these may also be provided to a fashion module 280 from another module or computing device. Notably, the compatibility scores 415 and style ratings 420 may be adjusted by clothing manufacturers or resellers to affect what advertising is generated by the advertising module, and ultimately to steer wearers into purchasing new (and presumably more fashionable) clothing items. Adjusting compatibility scores 415 and style ratings 420 may be done independently of any measure of wear of the wearer's current clothing, or may be performed together.

The compatibility scores 415 and style ratings 420 may be used to generate a composite fashion score 272 for the wearer, which may be saved into the wearer's profile. The fashion score 272 may provide a weighted combination of compatibility scores 415 and style ratings 420 for one or more articles of clothing 410. In one embodiment, the fashion score 272 may be calculated when a wearer is simultaneously wearing two or more sensor-enabled articles of clothing 410, which couple to one or more receivers of the advertising system. In another embodiment, the fashion score 272 may be calculated based on clothing included in the wearer's profile. The fashion score 272 may be used by an advertising module to suggest alternate clothing or accessories that would improve compatibility scores and/or style ratings 420. For example, the fashion module 280 may compare the wearer's current clothing (whose sensor devices have coupled to the receivers) with other available clothing items or accessories before generating an advertisement. If adding to or replacing a current clothing item with a particular clothing item or accessory is determined to improve the wearer's fashion score (or to improve it more than a threshold amount), the advertising module may recommend the clothing item/accessory.

In one embodiment, the fashion score 272 of a particular wearer may be compared with the fashion scores of other wearers. The comparison may be performed as part of a game or other competition, whether of a finite time duration or continuous. By adding a competitive aspect to the scoring (i.e., by encouraging wearers to improve their own fashion scores and beat other wearers), the advertising may produce more effective results (i.e., greater sales generated as a result).

In one embodiment, the advertising module may also incentivize users to wear the sensor-enabled clothing more frequently. For example, chart 400 may include counters for each clothing item 410 that reflect a number of times the clothing item has been worn, or has been coupled to a computing device (e.g., the clothing is worn in a store or other location). The advertising module may provide incentives to a wearer, such as monetary compensation, coupons, points redeemable for goods or services, etc. for wearing the clothing items. By encouraging the increased frequency of wear of clothing items, a clothing manufacturer or reseller may thereby increase the visibility of their clothing in public, which may increase exposure of the clothing to (and promote sales from) potential customers. Additionally, the increased frequency of wear may also increase the sales of replacement clothing items, as clothing items are worn more often, and may wear out relatively sooner.

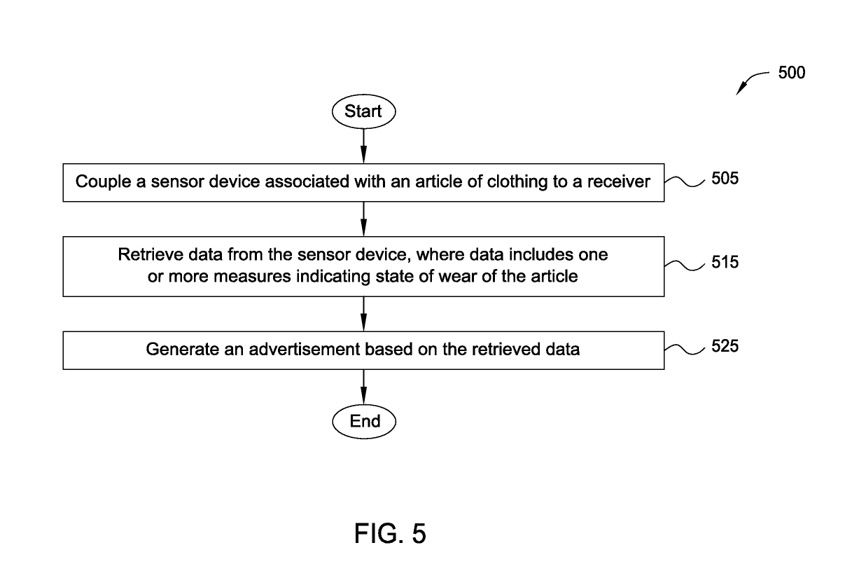

FIG. 5 illustrates a method for advertising, according to one embodiment described herein. The method 500 may generally be used by the various advertising systems described above.

Method 500 begins at block 505, where a body-worn sensor device that is associated with an article of clothing couples to a receiver. The coupling may be wireless, as a wearer of the clothing comes within a communication range of the receiver and sensor device.

At block 515, data is retrieved from the sensor device. The data includes one or more measures that indicate a state of wear of the article of clothing.

At block 525, an advertisement is generated based on the retrieved data. Among other factors, the advertisement may be based on a calculated wear score or estimated end-of-life for the clothing, or a calculated fashion score. The advertisement may be displayed to the wearer at a selected location or device in the store based on the wearer's current location and direction of movement, or the advertisement may be sent directly to their personal electronic devices, such as a cellular phone. Method 500 ends following completion of block 525.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the present invention, a user such as a retailer or a wearer/consumer may access applications (e.g., various modules of the advertising system) or related data available in the cloud. For example, the fashion module could execute on a computing system in the cloud and instantly deliver compatibility scores and style ratings for various articles and combinations of articles of clothing. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

1. A system, comprising:
a receiver configured to receive data wirelessly from a body-worn sensor device, wherein the received data includes one or more measures indicating a state of wear of an article of clothing associated with the sensor device; and
a computing device coupled to the receiver and comprising:
an advertising module configured to generate an advertisement based on data received from the sensor devices, and
a display module configured to present the advertisement.

2. The system of claim 1, wherein the advertisement is selected to target a wearer of the sensor device.

3. The system of claim 1, wherein the display module is configured to transmit the advertisement to an electronic device of the wearer.

4. The system of claim 1, further comprising a display device coupled to the display module and configured to display the advertisement.

5. The system of claim 1, wherein the computing device further comprises a wear module configured to generate a wear score based on the received data, and wherein the advertising module is further configured to generate the advertisement based on the wear score.

6. The system of claim 1, wherein the wear module is further configured to estimate an end-of-life for the clothing based on the received data, and wherein the advertising module is further configured to generate the advertisement based on the estimated end-of-life.

7. The system of claim 1, wherein the computing device further comprises a locator module configured to determine a current location of the one or more articles of clothing, and wherein the display module is further configured to select a display location for the advertisement based on the current location.

8. The system of claim 1, wherein the computing device further comprises a fashion module configured to generate a fashion score based at least on a first article of the one or more articles of clothing, and wherein the advertising module is further configured to generate the advertisement for a second article of clothing based on the fashion score.

9. A non-transitory computer-readable medium storing computer-readable code, which when executed on a processor, performs an operation comprising:
retrieving data from a body-worn sensor device, wherein the data includes one or more measures indicating a state of wear of a first article of clothing associated with the sensor device; and
generating an advertisement based on the retrieved data.

10. The computer-readable medium of claim 9, wherein the data is retrieved wirelessly when the sensor device is proximate to a receiver.

11. The computer-readable medium of claim 9, wherein the operation further comprises generating a wear score for the first article of clothing based on the retrieved data, and wherein generating the advertisement is based on the wear score.

12. The computer-readable medium of claim 9, wherein the operation further comprises estimating an end-of-life for the first article of clothing based on the received data, and wherein generating the advertisement is based on the estimated end-of-life.

13. The computer-readable medium of claim 9, wherein the operation further comprises determining a current location of the first article of clothing, and selecting a display location for the advertisement based on the determined location.

14. The computer-readable medium of claim 9, wherein the first article of clothing is associated with a profile of the wearer, and wherein the operation further comprises generating a fashion score based at least on the first article and generating an advertisement for a second article of clothing based on the fashion score.

15. A method for advertising, comprising:
coupling a body-worn sensor device to a receiver;
retrieving data from the sensor device that includes one or more measures indicating a state of wear of a first article of clothing associated with the sensor device; and
generating an advertisement based on the retrieved data.

16. The method of claim 15, wherein coupling the sensor device occurs wirelessly when the first article of clothing is proximate to the receiver.

17. The method of claim 15, further comprising generating a wear score for the first article of clothing based on the retrieved data, and wherein generating the advertisement is based on the wear score.

18. The method of claim 15, further comprising estimating an end-of-life for the first article of clothing based on the received data, and wherein generating the advertisement is based on the estimated end-of-life.

19. The method of claim 15, wherein the first article of clothing is associated with a profile of a wearer of the first article, the method further comprising generating a fashion score based at least on the first article and generating an advertisement for a second article of clothing based on the fashion score.

20. The method of claim 15, further comprising transmitting the advertisement to an electronic device of a wearer of the first article of clothing.
